(19) United States
(12) Patent Application Publication
(10) Pub. No.: US 2021/0368769 A1
(43) Pub. Date: Dec. 2, 2021

(54) COLLECTION PANEL

(71) Applicant: EXEL INDUSTRIES, Paris (FR)

(72) Inventor: Josep GODIA, PARIS (FR)

(21) Appl. No.: 16/767,047

(22) PCT Filed: Nov. 27, 2018
(86) PCT No.: PCT/FR2018/053005

§ 371 Date: May 26, 2020

(30) Foreign Application Priority Data
Nov. 27, 2017 (FR) 1761227

(51) Int. Cl. A01M 7/00; B05B 12/36

(52) U.S. Cl. CPC A01M 7/0014; B05B 12/36; A01M 7/0075; A01M 7/0085

(57) ABSTRACT

This collection panel for an agricultural sprayer forms a hollow box comprising an air inlet opening and openings or pre-openings capable of receiving pulsed-air spraying assemblies.

The present invention relates to a collection panel for an agricultural sprayer, a device for supporting such a panel, and a sprayer equipped with such panels borne by such devices.

As is known per se in the field of agricultural spraying, a recurring problem lies in collecting the portion of the phytosanitary liquid that is not deposited on the crops to be treated.

Indeed, it is estimated that, during a spraying operation, merely 30% of the phytosanitary liquid remains fixed on the foliage of the crops to be treated.

The remainder of the liquid is either diffused into the air, or scattered on the ground, by gravity.

In the current context in which it is sought to limit the environmental impact of spraying operations, as well as make significant savings of the quantities of phytosanitary liquid sprayed, it is essential to develop means for developing losses of this liquid.

Thus, in the prior art, particularly phytosanitary liquid collection panels, forming kinds of shields—also known as screens—have been placed around spray nozzles, for collecting a portion of the phytosanitary liquid which is not fixed on the crops of the foliage to be treated.

In these collection panels according to the prior art, complex networks of pipes for supplying the various spray nozzles are found: these panels are thus heavy and complex to clean.

Furthermore, these panels are designed to always be positioned parallel with the rows of crops to be treated, which renders same difficult to manoeuvre and adapt to different operating configurations (driving on roads, U-turn at end of row, etc.).

The present invention is intended particularly to enhance the design, manoeuvrability and efficiency of such collection panels.

This aim is achieved with a collection panel for an agricultural sprayer, forming a hollow box comprising an air intake opening, and openings or pre-openings suitable for receiving pulsed air type spraying assemblies.

This hollow box design with orifices of the collection panel makes it possible to do away with all the pipework of the devices according to the prior art, required to convey the air to the spray nozzles: in this way, a simplified design of the collection panel is obtained, suitable for both spraying the phytosanitary product and collecting the sprayed phytosanitary product that is not fixed on the crops of the foliage to be treated, such a panel requiring few parts, being easy to clean (absence of inaccessible recesses and locations inside the box), and having a reduced weight with respect to the solutions known from the prior art.

According to other optional features of the collection panel according to the invention:
said panel comprises ribs on the working face thereof: the presence of the ribs on the working face of each collection panel makes it possible to prevent bouncing on this panel of the droplets of phytosanitary liquid returned by the crop foliage; by preventing this bouncing, the quantity of phytosanitary liquid dispersed into the environment is limited; these ribs furthermore help reinforce the structural strength (resistance to deformations) of the collection panel,
said ribs have a substantially triangular cross-section, and extend along a vertical direction in the working position,
this collection panel comprises a phytosanitary liquid collection tank at the bottom in the working position, suitable for being connected to a pipe for collecting this liquid,
this collection panel is equipped on the face thereof opposite the working face thereof with a groove suitable for receiving a phytosanitary liquid intake pipe,
this collection panel is one-piece,
said openings or pre-openings suitable for receiving pulsed air type spray assemblies are disposed symmetrically on either side of said ribs,
this collection panel comprises air outlet orifices or pre-orifices disposed symmetrically on a single side or on either side of said ribs, and/or above and/or below said ribs in the working position: these openings or pre-openings make it possible to form peripheral air curtains suitable for containing the phytosanitary liquid spray, particularly in the presence of wind; this particularly makes it possible to envisage spraying with a greater forward speed of the agricultural machinery, typically around 20% greater than a conventional forward speed;
this collection panel is formed of rigid or flexible polyethylene.

The present invention also relates to a device for supporting a collection panel as described above, comprising a fastening frame at the top of said panel in the working position, a male head fixedly mounted on this frame equipped with a male air flow duct, a female head receiving said male head in a pivoting manner and equipped with a female air flow duct wherein said male duct extends, a cylinder actuator inserted between said female and male heads, and means for connecting said female head to hinged suspension arms on said sprayer.

The present invention also relates to a sprayer equipped with collection panels as described above, borne by respective supporting devices as described above, wherein said collection panels are movable between a working position wherein these panels are disposed parallel with one another at the rear of said sprayer, and a storage position wherein at least some of these panels are stored on the sides of the sprayer, parallel with the working position thereof, or indeed on top of said sprayer.

The present invention also relates to a sprayer equipped with collection panels as described above, borne by respective supporting devices as described above, wherein in the working position, said panels are disposed so as to form pairwise open angles at the front of said sprayer.

Further features and advantages of the presence invention will emerge in the light of the following description, and on studying the appended figures, wherein:

FIG. 1 is a perspective view of an agricultural sprayer supporting collection panels according to the invention, spanning a row of crops to be treated,

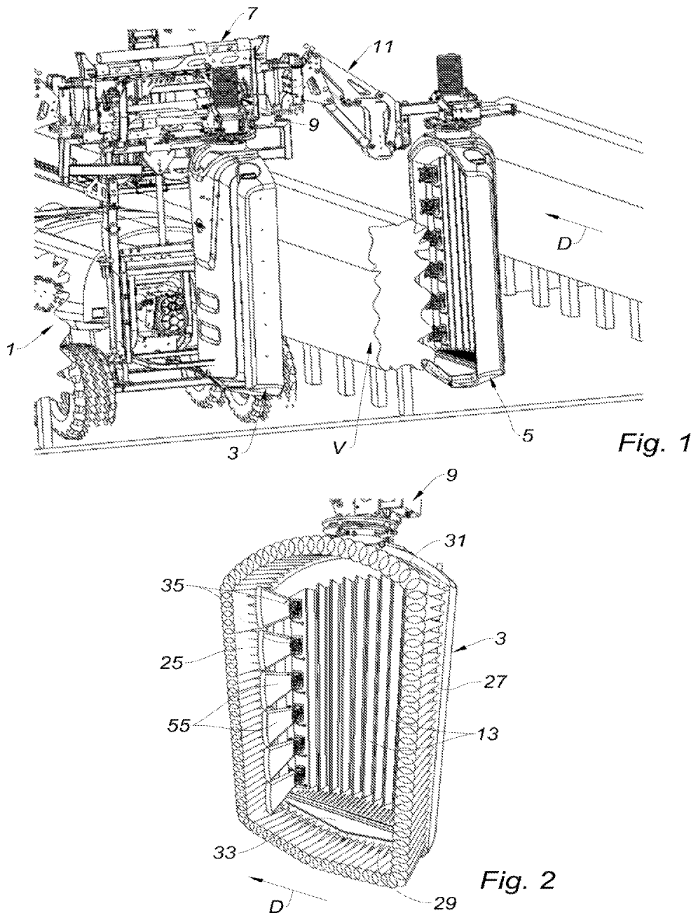

FIG. 2 is a perspective view of one of the collection panels of the sprayer in FIG. 1, representing symbolically different operational air jets when the sprayer is in working mode,

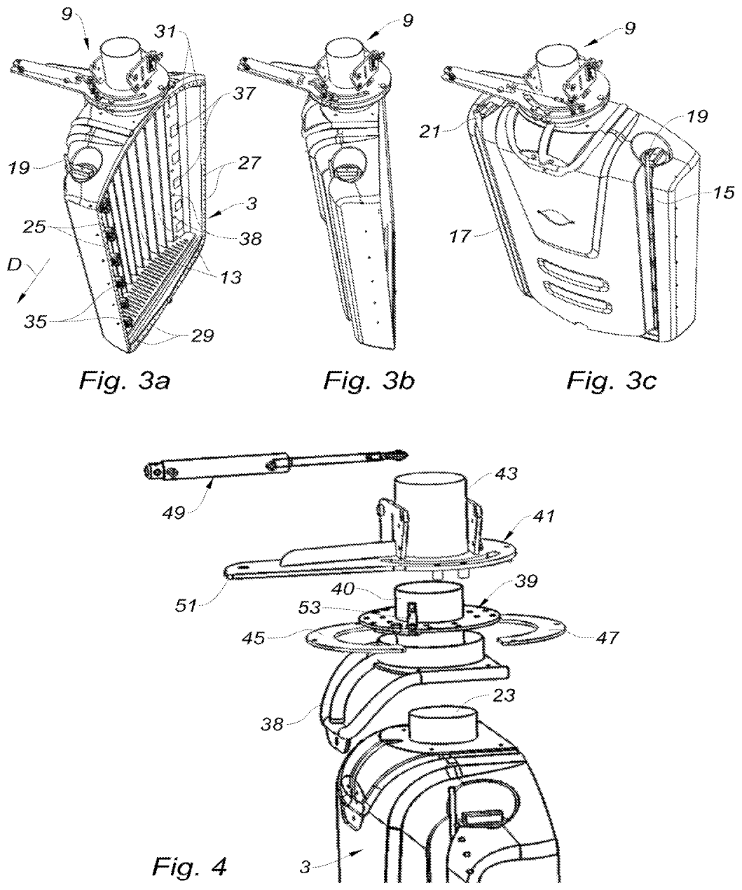

FIGS. 3a, 3b, 3c show this collection panel oriented in different ways with respect to the supporting device thereof,

FIG. 4 is an exploded perspective view of the top of this collection panel and of the supporting device thereof,

FIG. 5 is a perspective top view of the sprayer according to the invention, representing one of the collection panels in the retracted position, particularly enabling road travel of this sprayer, as well as easier turning at the end of rows, helping prevent catching on the crops,

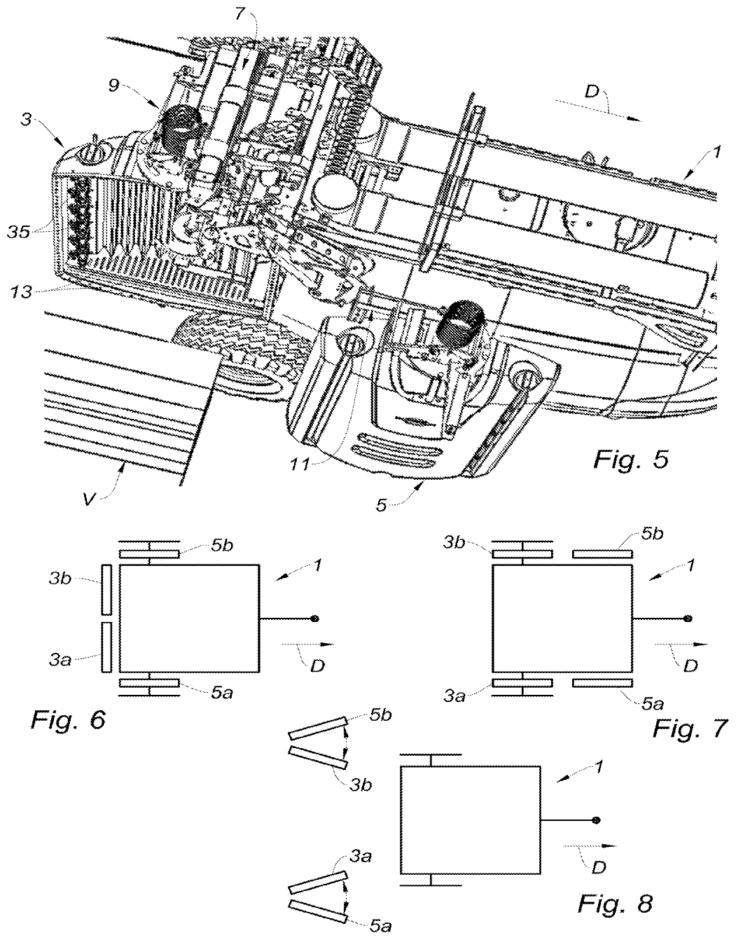

FIGS. 6 and 7 are schematic views of possible storage modes of the collection panels with respect to the main part of the sprayer, and

FIG. 8 is a perspective view of a possible working position of the collection panels of a sprayer according to the invention.

Reference is now made to FIG. 1, representing a spraying machine 1 (in this instance, a towed sprayer), supporting collection panels 3, 5 according to the invention by means of a hinged suspension mechanism 7, particularly comprising supporting devices 9, 11.

As seen in FIG. 1, when the spraying machine 1 travels along the forward travel direction D, the collection panels 3, 5 disposed on either side of the crops to be treated V, make it possible to spray on the foliage of these crops a phytosanitary liquid suitable for carrying out a suitable treatment of these crops.

With reference more particularly to FIGS. 2 and 3a to 3c, it can be seen that a collection panel 3 according to the invention is presented in the form of a preferably one-piece box, formed of a thermoplastic material such as rigid or flexible polyethylene. This box delimits a hollow volume inside which the air supplying the spraying assembly/assemblies may flow.

In other words, this box has a hollow shape similar to a boat delimited by a rear face equipped with a substantially closed and/or watertight wall and a front face where both the spraying of the phytosanitary product and the collection of the sprayed phytosanitary product that is not fixed on the crops of the foliage to be treated are carried out. Such a “boat” shape would be able to float on water thanks to such a shape and such a watertight rear face.

In the working face thereof, i.e. on the face intended to be facing the crops to be treated, the box 3 includes a plurality of ribs 13 extending substantially along a vertical direction, and practically along the entire height of the collection panel, the vertical extending with respect to the working position of this panel, as represented in FIG. 1.

Preferably, these ribs 13 may each have a substantially triangular cross-section.

On the face thereof opposite the working face thereof, particularly seen in FIG. 3c, this collection panel includes grooves 15, 17, suitable for receiving respectively a phytosanitary liquid intake pipe 19, and a pipe 21 for collecting a portion of this liquid.

As represented in FIG. 4, in the top part thereof, the box forming the collection panel 3 includes an air intake opening 23.

As seen particularly in FIGS. 2 and 3a, the collection panel 3 includes, on the lateral edges thereof, a plurality of lateral air outlet orifices 25, 27.

As also seen in these two figures, this collection panel also includes lower 29 and upper 31 air outlets.

As seen in FIG. 2, the collection panel 3 also includes, in the bottom part thereof, a phytosanitary liquid collection tank 33, connected to the phytosanitary liquid collection pipe 21 in FIG. 3c.

As seen FIGS. 2 and 3a, the collection panel 3 includes, on the working face thereof, and to the front of the collection panel with respect to the direction of travel D in working mode, a plurality of a pulsed air spraying assemblies 35.

These assemblies 35, which will not be detailed herein, each include an air diffuser communicating with the hollow space of the box forming the collection panel 3, and a spray nozzle connected to the phytosanitary liquid intake pipe 15.

These spraying assemblies 35 are positioned in openings formed in the box defining the collection panel 3. Pre-openings 37, 38 are disposed symmetrically on this box, as seen in FIG. 3a, in order to make it possible to position respectively the air diffusers and the spray nozzles the spraying assemblies 35 symmetrically on the working face of the collection panel 3, in order to enable left/right mounting reversibility of this collection panel.

In order to carry out spraying, the air flowing in the box supplies propellant air to the spraying assembly 35. The propellant air enters via an inlet of the spraying assembly, traverses same from end to end and emerges via an opening at the outlet, in the form of an air jet directed towards the crops to be treated. The spraying assembly performs a function of shaping the air jet and dispensing same to the crops to be treated. The phytosanitary product is dispersed at the outlet opening of the nozzle so as to be carried or blown by the air jet into the foliage of the crops to be treated.

The spraying assembly is an assembly suitable for diffusing air and spraying phytosanitary product. Such an assembly is also known as a nozzle or nozzle block and can be considered as an assembly configured to mix a phytosanitary product with the propellant air to form an aerosol, i.e. to spray and diffuse the aerosol.

Preferably, this spraying assembly 35 is removable in one piece from the wall bearing same to facilitate the maintenance thereof.

With reference now more particularly to FIG. 4, it can be seen that the device for supporting the collection panel 3 according to the invention includes, on one hand, a fastening frame 38 fastened to the top of the collection panel 3, in turn fixed connected to a male head 39 in turn pivotably mounted with respect to a female head 41.

This male head 39 includes a male duct 40 communicating with the intake orifice 23 of the collection panel 3, and fitted inside a female duct 43 rigidly connected to the female head 41.

Two half-discs 45, 47 fastened to the female head 41 only allow a rotational movement of the male head 39 with respect to the female head 43.

A cylinder actuator 49 inserted between an extension 51 of the female head 41 and an actuation piece 53 rigidly connected to the male head 39, makes it possible to actuate this male head 39 in rotation with respect to the female head 43, and thereby perform a rotational movement of the collection panel 3 with respect to a substantially vertical axis.

In FIGS. 3a to 3c, different possible orientations of the collection panel 3 with respect to the female head 41 are represented: in FIG. 3a, the extension 51 of the female head 41 is oriented substantially perpendicularly to the general plane of the collection panel 3: this position corresponds to the working position of the collection panel, represented in FIG. 1.

In FIG. 3b, the collection panel 3 is pivoting under the effect of the actuation of the cylinder actuator 49 from the working position to the storage position (the latter being seen in FIG. 3c), wherein the extension 51 of the female head 41 is located substantially in the general plane of the collection panel 3.

This storage position is particularly seen in FIG. 5, wherein it can be seen that the collection panel 5, connected to the supporting device 9 thereof, is substantially stored along the main body of the sprayer 1.

For this particular sprayer, in the storage position, the other associated collection panel 3 remains positioned at the rear of the main body of the sprayer.

Obviously, further storage kinematics of the collection panels may be envisaged, as represented in FIGS. 6 and 7, schematically.

In FIG. 6, the collection panels 5a and 5b are stored along the body of the sprayer 1, and two other collection panels 3a and 3b are stored along the rear of this body.

In FIG. 7, all the collection panels 3a, 5a and 3b, 5b are stored on the sides of the body of the sprayer 1.

It could also be envisaged that at least some of the collection panels are stored on the top of the body of the sprayer.

The operating mode and the advantages of the present invention result directly from the above description.

In the working position, the collection panels 3, 5 span pairwise the row of crops to be treated V, as represented in FIG. 1.

Pressurised phytosanitary liquid arrives from the tank of the sprayer 1 via the liquid intake pipes 19 (FIG. 3c) disposed on each collection panel 3.

This phytosanitary liquid is sprayed by the nozzle assemblies 35 disposed on the working face of the collection panel 3 (FIG. 2).

Moreover, pressurised air generated by a compressed air generation unit, arrives via the upper opening 23 (FIG. 4) of the collection panel, after traversing the female 43 and male 40 ducts of the device for supporting the collection panel.

This pressurised air will fill the internal volume of the box forming the collection panel 3 by creating a pressure chamber, suitable for supplying the air diffusers of the spraying assemblies 35.

This thus makes it possible to generate pulsed air jets 55 (see FIG. 2), suitable for enhancing the projection of the phytosanitary liquid on the foliage of the crops V.

Moreover, the pressure chamber in the box forming the volume of the collection panel 3, will also make it possible to expel the air via the lateral 25, 27, lower 29 and upper 31 orifices of the collection panel.

These lateral, lower and upper orifices make it possible to create an air curtain containing the spray cloud generated by the nozzle assemblies 35.

More particularly, the lower, rear and upper air curtains generated respectively by the orifices 29, 27 and 31 seen in FIG. 2, make it possible to contain a large portion of the phytosanitary product that does not reach or does not remain on the foliage of the crops to be treated.

The air curtain generated by the orifices 25 located on the front edge (with respect to the direction and forward travel D in working mode) of the collection panel 3 makes it possible to shake the foliage of the crops to be treated immediately upstream from the spraying assemblies 35, and thus expose the foliage thereof optimally to the jet of phytosanitary product to be sprayed.

The ribs 13 (FIG. 2) disposed on the working face of the collection panel 3 make it possible to prevent bouncing of the droplets of phytosanitary liquid returned by the crop foliage; after striking these ribs, the droplets trickle into the collection tank 33, which returns the liquid collected to the phytosanitary liquid tank of the sprayer, via the return pipe 21 (FIG. 3c).

By actuating each of the cylinder actuators 49 (FIG. 4), it is possible to modify the orientation of each collection panel 3 with respect to the body of the sprayer 1, as seen in FIGS. 3a, 3b and 3c.

In particularly, it is possible to switch these collection panels from the working position represented in FIG. 1, to the storage position represented in FIG. 5 or in FIGS. 6 and 7, as previously explained above.

It is also possible advantageously, in working mode, to modify the respective orientation of the collection panels 3a, 5a and 3b, 5b, as represented in FIG. 8, i.e. for example by forming an open angle to the front of the sprayer, so as to better receive and surround the crops to be treated between each pair of collection panels.

Each collection panel is designed to be able to be used indifferently as a left or right collection panel.

For this purpose, the orifices intended to receive the spraying assemblies 35 are pre-drilled on each side of the working face of the collection panel, then drilled at the time of installation of these spraying assemblies according to the left or right destination of each panel.

Obviously, the present invention is in no way limited to the embodiment described and represented, provided merely by way of example.

1. Collection panel (3, 5; 3a, 3b, 5a, 5b) for an agricultural sprayer (1), forming a hollow box comprising an air intake opening (23), and openings or pre-openings (37, 38) suitable for receiving pulsed air type spraying assemblies (35).

2. Collection panel (3, 5; 3a, 3b, 5a, 5b) according to claim 1, equipped with ribs (13) on the working face thereof.

3. Collection panel (3, 5; 3a, 3b, 5a, 5b) according to claim 2, wherein said ribs (13) have a substantially triangular cross-section, and extend along a vertical direction in the working position.

4. Collection panel (3, 5; 3a, 3b, 5a, 5b) according to claim 1, comprising a phytosanitary liquid collection tank (33) at the bottom in the working position, suitable for being connected to a pipe for collecting this liquid (21).

5. Collection panel (3, 5; 3a, 3b, 5a, 5b) according to claim 1, equipped on the face thereof opposite the working face thereof with a groove (15) suitable for receiving a phytosanitary intake pipe (19).

6. Collection panel (3, 5; 3a, 3b, 5a, 5b) according to claim 1, that is one-piece.

7. Collection panel (3, 5; 3a, 3b, 5a, 5b) according to claim 3, wherein said openings or pre-openings (37, 38) suitable for receiving pulsed air type spraying assemblies (35), are disposed symmetrically on either side of said ribs (13).

8. Collection panel (3, 5; 3a, 3b, 5a, 5b) according to claim 3, comprising air outlet orifices or pre-orifices disposed symmetrically on a single side or on either side (25, 27) of said ribs (13), and/or above (31) and/or below (29) said ribs (13) in the working position.

9. Collection panel (3, 5; 3a, 3b, 5a, 5b) according to claim 1, formed of rigid or flexible polyethylene.

10. Supporting device (9, 11) for a collection panel (3, 5; 3a, 3b, 5a, 5b) according to claim 1, comprising a fastening frame (38) at the top of said panel in the working position, a male head (39) fixedly mounted on this frame (38) equipped with a male air flow duct (40), a female head (41) receiving said male head (39) in a pivoting manner and equipped with a female air flow duct (43) wherein said male duct (40) extends, a cylinder actuator (49) inserted between said female (41) and male (39) heads, and means for connecting said female head (41) to hinged suspension arms on said sprayer (1).

11. Sprayer (1) equipped with collection panels (3a, 3b, 5a, 5b) borne by respective supporting devices (9, 11) according to claim 10, wherein said collection panels (3a, 3b, 5a, 5b) are movable between a working position wherein these panels are disposed parallel with one another at the rear of said sprayer (1), and a storage position wherein at least some of these panels are stored on the sides of the sprayer, parallel with the working position thereof, or indeed on top of said sprayer.

12. Sprayer (1) equipped with collection panels (3a, 3b, 5a, 5b) borne by respective supporting devices (9, 11) according to claim 10, wherein in the working position, said panels are disposed so as to form pairwise open angles at the front of said sprayer.
